(19) United States
(12) Patent Application Publication
(10) Pub. No.: US 2012/0240600 A1
(43) Pub. Date: Sep. 27, 2012

(54) METHOD OF HANDLING A BOIL OFF GAS STREAM AND AN APPARATUS THEREFOR

(76) Inventors: Peter Marie Paulus, Amsterdam (NL); Kornelis Jan Vink, Kuala Lumpur (MY)

(21) Appl. No.: 13/510,055

(22) PCT Filed: Nov. 16, 2010
(86) PCT No.: PCT/EP2010/067538

§ 371 Date: May 16, 2012

(30) Foreign Application Priority Data
Nov. 18, 2009 (EP) 09176356.5

(51) Int. Cl. F17C 9/04; F17C 5/04

(52) U.S. Cl. 62/48.2; 62/48.1

(57) ABSTRACT

A boil-off gas (BOG) stream (15) from a liquefied hydrocarbon storage tank is split into a BOG heat exchanger feed stream (25) and a BOG bypass stream (35). The BOG heat exchanger feed stream (25) is heat exchanged in a BOG heat exchanger (40) against a process stream (135), thereby providing a warmed BOG stream (45) and a cooled process stream (195). The warmed BOG stream (45) is combined with the BOG bypass stream (35) to provide a temperature controlled BOG stream (55). Herein, the mass flow of the process stream (135) is controlled in response to a measured first temperature of at least one of (i) the warmed BOG stream (45) and (ii) the cooled process stream (195) to move the measured first temperature towards a first set point temperature; and the mass flow of one or both of the BOG heat exchanger feed stream (25) and the BOG bypass stream (35) are controlled in response to a measured second temperature of the temperature controlled BOG stream (55), to move the measured second temperature towards a second set point temperature.

The present invention provides a method of handling a boil off gas stream from a cryogenically stored liquefied hydrocarbon inventory, and an apparatus therefor.

An economically important example of a cryogenically stored liquefied hydrocarbon inventory is liquefied natural gas (LNG). Liquefied natural gas may be stored at about −162° C. under approximately atmospheric pressure.

Natural gas is a useful fuel source, as well as being a source of various hydrocarbon compounds. It is often desirable to liquefy natural gas in a liquefied natural gas (LNG) plant at or near the source of a natural gas stream for a number of reasons. As an example, natural gas can be stored and transported over long distances more readily as a liquid than in gaseous form because it occupies a small volume and does not need to be stored at high pressure.

Usually, natural gas, comprising predominantly methane, enters an LNG plant at elevated pressures and is pre-treated to produce a purified feed stream suitable for liquefaction at cryogenic temperatures. The purified gas is processed through a plurality of cooling stages using heat exchangers to progressively reduce its temperature until liquefaction is achieved. The liquefied natural gas is then further cooled and expanded to final atmospheric pressure suitable for storage and transportation.

The liquefied natural gas is normally stored under cryogenic conditions. Temperature variations during LNG storage and handling can result in the vaporisation of a portion of the liquefied natural gas as natural gas vapour, also called boil off gas (BOG). Boil off gas may be produced from liquefied natural gas held in cryogenic storage tanks, or as a result of passage of the LNG through insufficiently cold pipelines, particularly during the transfer of LNG from a cryogenic storage tank to a LNG carrier vessel.

U.S. Pat. No. 6,658,892 discloses a process for liquefying natural gas in which the boil off gas from LNG storage tanks is passed by a blower through a common reject gas heat exchanger, to provide a warmed boil off gas stream. The warmed boil off gas stream is combined with a warmed end flash gas stream prior to compression in a common fuel gas compressor. The common reject gas heat exchanger provides cold recovery to a warm line fluid stream. The warm line fluid stream can comprise a portion of the feed gas, scrub column overhead gas and/or other fluids.

The combined warmed boil off gas stream and warmed end flash gas stream passed to the common fuel gas compressor may vary in temperature depending upon the mode in which the liquefaction plant is operated.

In holding mode, LNG produced by the liquefaction plant is transferred to the cryogenic storage tanks. The boil off gas produced from the cryogenic storage tanks will be at a steady temperature, for instance at less than −150° C. However, when a LNG carrier vessel is being loaded with LNG and the liquefaction plant is placed in loading mode, additional boil off gas may be produced by the cooling of the communicating pipelines and vessel storage tanks. The boil off gas can be returned from the communicating pipelines and/or carrier vessel to the liquefaction plant by one or more blowers. The operation of the blowers can produce boil off gas at a different temperature, often significantly warmer, than the boil off gas produced from the storage tanks of the liquefaction plant, for instance due to superheating. This means that a common fuel gas compressor, such as that disclosed in U.S. Pat. No. 6,658,892 would be required to handle differing amounts of fluid at a range of suction temperatures.

As the temperature of the combined warmed boil off gas stream and warmed end flash gas stream passed to the common fuel gas compressor changes, for instance between loading and holding modes, the density of the fluid at the compressor inlet will change. This corresponds to a change in mass flow. Decreases in mass flow away from the designed operating conditions may result in a reduction in the specific power or efficiency of the compressor.

Thus, these variations in the temperature may make the further processing of this stream more difficult, for instance if it is desired to compress this stream, for instance to provide fuel gas.

The present invention provides a method of handling a boil off gas stream from a cryogenically stored liquefied hydrocarbon inventory, comprising at least the steps of:

providing a boil off gas stream from a liquefied hydrocarbon storage tank;

splitting the BOG stream into a BOG heat exchanger feed stream and a BOG bypass stream;

heat exchanging the BOG heat exchanger feed stream in a BOG heat exchanger against a process stream, thereby providing a warmed BOG stream and a cooled process stream;

combining the warmed BOG stream with the BOG bypass stream to provide a temperature controlled BOG stream; wherein, the mass flow of the process stream is controlled in response to a measured first temperature of at least one of (i) the warmed BOG stream and (ii) the cooled process stream to move the measured first temperature towards a first set point temperature, and the mass flow of one or both of the BOG heat exchanger feed stream and the BOG bypass stream are controlled in response to a measured second temperature of the temperature controlled BOG stream, to move the measured second temperature towards a second set point temperature.

In a further aspect, the present invention provides an apparatus for handling a BOG stream from a cryogenically stored liquefied hydrocarbon inventory, said apparatus comprising at least:

a liquefied hydrocarbon storage tank for storing the liquefied hydrocarbon inventory, the liquefied hydrocarbon storage tank having a first inlet for allowing entry of a liquefied hydrocarbon stream into the liquefied hydrocarbon storage tank and a first outlet for allowing the BOG stream to pass out of the liquefied hydrocarbon storage tank;

a first flow splitting device to divide the BOG stream into a BOG heat exchanger feed stream and a BOG bypass stream;

a BOG heat exchanger for warming the BOG heat exchanger feed stream by heat exchanging against a process stream, the BOG heat exchanger having a first inlet for receiving the BOG heat exchanger feed stream and a first outlet for discharging a warmed BOG stream, and a second inlet for receiving the process stream and a second outlet for discharging a cooled process stream;

a first stream combining device to combine the BOG bypass stream and the warmed BOG stream to provide a temperature controlled BOG stream;

one or more flow control valves to control the mass flow of at least one of the BOG heat exchanger feed stream and the BOG bypass stream;

a process stream valve to control the mass flow of the process stream;

a first temperature controller to determine a measured first temperature of at least one of (i) the warmed BOG stream and (ii) the cooled process stream and having a first set point temperature, said first temperature controller arranged to adjust the process stream valve to move the measured first temperature towards the first set point temperature; and

a second temperature controller to determine a measured second temperature of the temperature controlled BOG stream and having a second set point temperature, said second temperature controller arranged to adjust the one or more flow control valves to move the measured second temperature towards the second set point temperature.

Embodiments of the present invention will now be described by way of example only and with reference to the accompanying non-limited drawings in which:

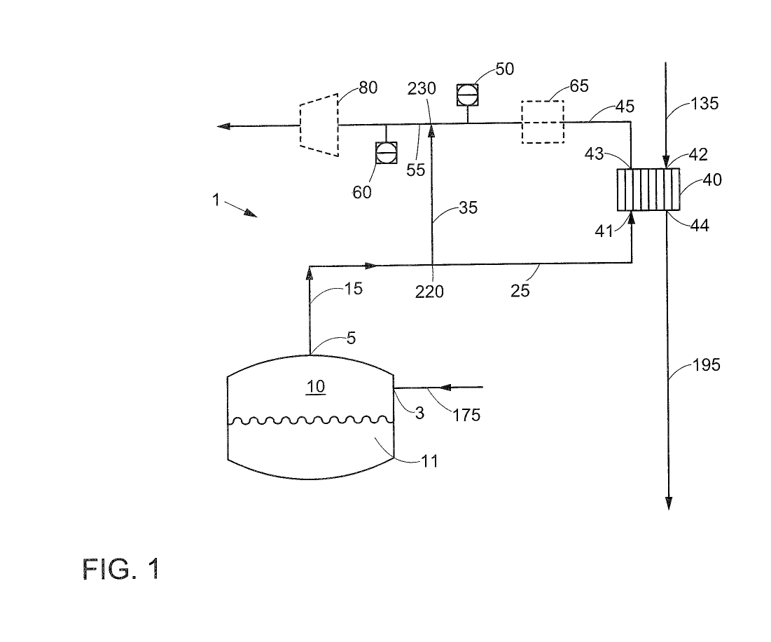

FIG. 1 is a diagrammatic scheme of a method of, and apparatus for, handling a boil off gas stream according to one embodiment;

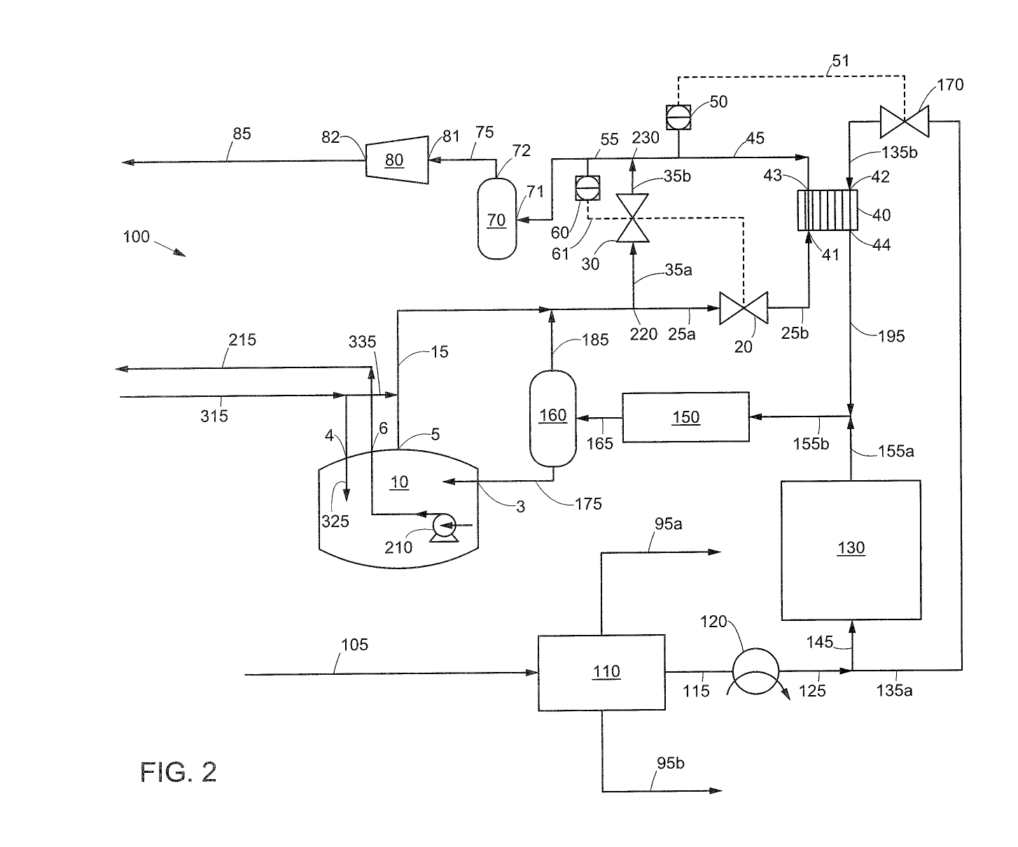

FIG. 2 is a diagrammatic scheme of a method of, and apparatus for, treating, cooling and liquefying a hydrocarbon stream, incorporating a method of and apparatus for handling a boil off gas stream according to a further embodiment; and

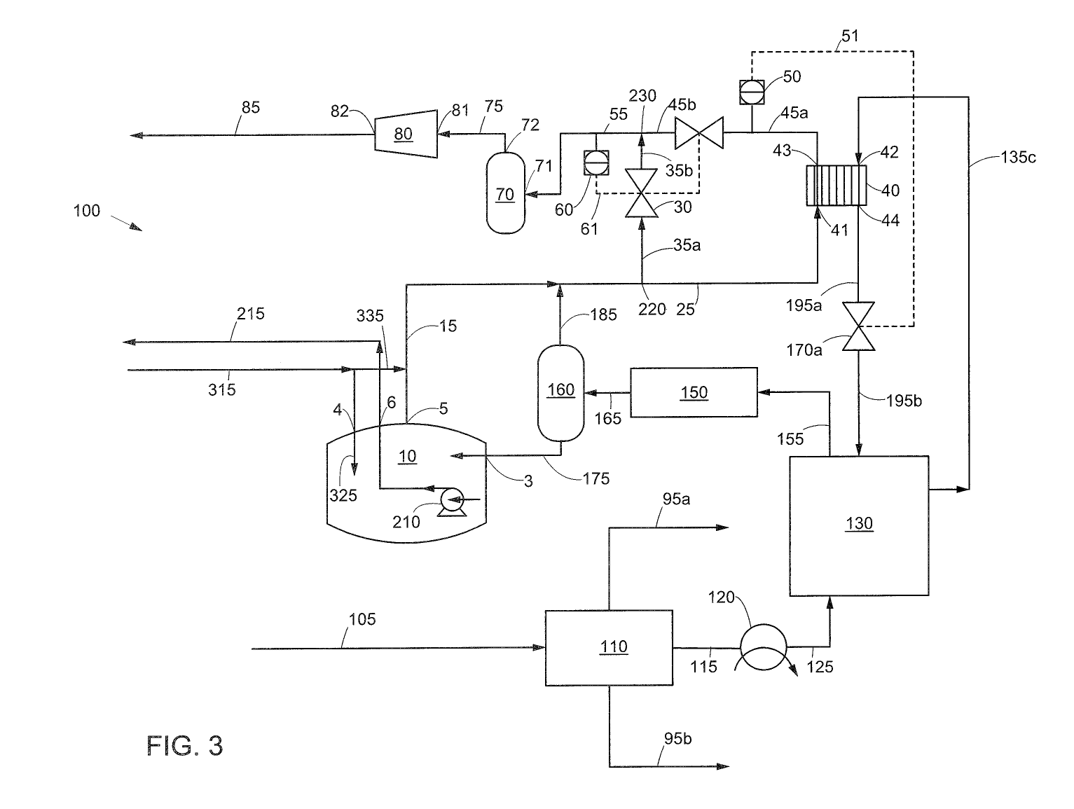

FIG. 3 is a diagrammatic scheme of a method of, and apparatus for, treating, cooling and liquefying a hydrocarbon stream, incorporating a method of and apparatus for handling a boil off gas stream according to a still further embodiment.

For the purpose of this description, a single reference number will be assigned to a line as well as a stream carried in that line. As used herein, the terms “flow” and “mass flow” when used in relation to a stream refer to “mass flow rate”.

By warming part of the BOG stream in a BOG heat exchanger, and combining the warmed part of the BOG stream with the BOG bypass stream, and controlling the mass flow of the process stream in response to a measured first temperature of at least one of (i) the warmed BOG stream and (ii) the cooled process stream, and controlling the mass flow of one or both of the part of the BOG stream to be warmed (or that has been warmed) and the BOG bypass stream, the temperature of a boil off gas stream can be controlled. The temperature controlled boil off gas stream may suitably be passed to a boil off gas compressor.

The boil off gas heat exchanger feed stream is warmed in a boil off gas heat exchanger against a process stream, such as a liquefaction process stream, to provide a warmed boil off gas stream at a measured first temperature. A first temperature controller may operate to control the level of heat exchange in the boil off gas heat exchanger. By altering the mass flow of the process stream passed to the boil off gas heat exchanger, the temperature of warmed boil off gas stream can be varied, and moved towards a first set point temperature. The first set point temperature can be pre-selected. The boil off gas heat exchanger can therefore provide a variable heating duty to the boil off gas heat exchanger feed stream, to control the temperature of the warmed boil off gas stream. The temperature of the warmed boil off gas stream is higher than the temperature of the original BOG stream.

The warmed boil off gas stream can then be combined with the boil off gas bypass stream to provide a temperature controlled boil off gas stream. The boil off gas bypass stream does not pass through the boil off gas heat exchanger and is therefore colder than the temperature of the warmed boil off gas stream. The temperature of the boil off gas bypass stream is substantially the same as the temperature of the original boil off gas stream. Thus, the warmed boil off gas stream is in effect used to heat the boil off gas bypass stream by direct heat exchange. A second temperature controller may operate to alter the mass flow(s) of one or both of the BOG heat exchanger feed stream and BOG bypass stream in order to control the direct heat exchanging with the warmed BOG stream. By altering the mass flows of one or both of the warmed boil off gas stream and the boil off gas bypass stream, the relative proportions of these streams making up the temperature controlled bypass stream can be varied, thus controlling the temperature of the combined stream. The temperature of the combined stream may thus be moved towards a second set point temperature by adjusting the mass flows of one or both of the two constituent streams, which will be at different temperatures, to provide the temperature controlled boil off gas stream.

As will be understood, the present invention may facilitate the processing of a boil off gas stream at a variety of temperatures, to provide a controlled temperature boil off gas stream. The controlled temperature boil off gas stream may be further processed, such further processing for instance comprising passing to the boil of gas compressor at a temperature at or close to the second set point temperature. This allows the boil off gas compressor to be operated at a desired suction temperature, which can be the design temperature, optimising the efficiency of the compressor.

Referring to the drawings, FIG. 1 shows a method of and apparatus 1 for handling a boil off gas stream 15 from a cryogenically stored liquefied hydrocarbon inventory 11 stored in a liquefied hydrocarbon storage tank 10. Liquefied hydrocarbon or hydrocarbon mixtures, such as liquefied natural gas, may be stored under cryogenic conditions, at or near atmospheric pressure. The liquefied hydrocarbon inventory 11 in the storage tank 10 may be provided via a first inlet 3, by adding a liquefied hydrocarbon stream 175. The liquefied hydrocarbon stream 175 can be provided by a liquefaction unit and this is discussed in greater detail below.

Rather than the storage tank of a liquefaction unit, in alternative embodiments, the storage tank may be that of an LNG carrier vessel, or may be a vessel or liquefaction unit storage tank supplied with the boil off gas from the loading of such a vessel.

A degree of vaporisation of the liquefied hydrocarbon is to be expected due to temperature fluctuations within the liquefied hydrocarbon storage tank 10, or the pipework conveying the liquefied hydrocarbon to the storage tank 10. This vaporised hydrocarbon, such as vaporised LNG, is flammable and can be removed from the storage tank 10 via outlet 5 as a vaporised hydrocarbon stream, normally termed a boil off gas (BOG) stream 15.

If the liquefied hydrocarbon storage tank 10 is being filled from an empty state, the tank may be above the storage temperature of the liquefied hydrocarbon, such that the liquefied hydrocarbon will cool the tank, resulting in a portion of the hydrocarbon being vaporised. Similarly, vaporised hydrocarbon returned from the carrier vessel by a blower during the loading operation may be superheated by the blower. Such vaporised hydrocarbon will be at a higher temperature that vaporised gas from a tank in a full, holding state. For instance, the temperature of the BOG stream 15 may vary in the range of −140 to −165° C. The lower temperatures in this range may occur in holding mode while the higher temperatures in the range may occur in loading mode.

The method and apparatus 1 disclosed herein seeks to provide a temperature controlled BOG stream 55. Such a stream can be further processed in further equipment, for example pressurised in an optional BOG compressor 80, without departing from the operational envelope of the equipment.

The BOG stream 15 is passed to a first flow splitting device 220, in which it is divided into a boil off gas heat exchanger feed stream 25 and a boil off gas bypass stream 35.

The BOG heat exchanger feed stream 25 is passed to the first inlet 41 of a boil off gas heat exchanger 40. The BOG heat exchanger 40 can be selected from the group consisting of printed circuit heat exchanger and spool wound heat exchanger. The BOG heat exchanger feed stream 25 is warmed against a process stream 135 provided to a second inlet 42 of the BOG heat exchanger 40, to provide a warmed boil off gas stream 45 at a first outlet 43 and a cooled process stream 195 at a second outlet 44.

The process stream 135 may be any appropriate process stream available which requires to be cooled. The process stream 135 should have a temperature greater than that of the BOG heat exchanger feed stream 25, and thus the boil off gas stream 15. It is preferred that the process stream 135 is provided at a set process stream temperature, although this is not essential. The process stream 135 can have a temperature in the range of −20 to −50° C. In this way, a part of the cold energy present in the BOG heat exchanger feed stream 25 is not wasted by heating against an ambient heat source and is instead passed to another process stream.

A first temperature controller 50 determines the temperature of the warmed BOG stream 45 as a measured first temperature (T1). The first temperature controller 50 also has a first set point temperature (SP1), which can be input by an operator. The first temperature controller 50 seeks to move the first temperature (T1) of the warmed BOG stream 45 to the first set point temperature (SP1). The first temperature controller 50 brings about the adjustment of the temperature of the warmed BOG stream 45 by controlling the mass flow of the process stream 135 through the BOG heat exchanger 40.

The mass flow of the process stream 135 through the BOG heat exchanger 40 is controlled by a process stream valve (not shown), which is placed in a conduit, either upstream or downstream of the heat exchanger 40, such that by adjusting the valve, the mass flow of the process stream 135 though the heat exchanger 400 can be changed. The embodiments of FIGS. 2 and 3 show possible locations for the process stream valve.

The setting of the process stream valve is adjusted by a process stream actuator instructed by a process valve control signal from the first temperature controller 50. For instance, if the measured first temperature is less than the first set point temperature, the first set point controller 50 will transmit a process valve control signal instructing the process stream actuator to change the setting of the process stream valve to increase the mass flow of the process stream 135 through the BOG heat exchanger 40, increasing the warming of the BOG heat exchanger feed stream 25. Similarly, if the measured first temperature is greater than the first set point temperature, the first set point controller 50 will transmit a process valve control signal instructing the process stream actuator to change the setting of the process stream valve to decrease the mass flow of the process stream 135 through the BOG heat exchanger 40, increasing the cooling of the BOG heat exchanger feed stream 25.

The first set point temperature may be in the range of −21 to −58° C., more preferably approximately −45 to −50° C. The choice of the first set point temperature may depend upon the designed approach temperature of process stream 135 to the BOG heat exchanger 40. In one embodiment, the first set point temperature may be, for example, a few degrees Centigrade lower than the temperature of the process stream 135, for instance 3° C. lower. The input first set point temperature of the first temperature controller 50 may depend upon the operational mode of the facility.

During holding mode when the boil off gas may be colder, but may have a smaller mass flow, compared to that produced during loading mode, the first temperature controller 50 can operate to warm the boil off gas against the process stream 135 in the BOG heat exchanger 40.

In loading mode, when the temperature of the boil off gas may be higher, the quantity of boil off gas produced may increase, increasing the mass flow of boil off gas stream 15. The total cooling duty available from the boil off gas will be higher such that the mass flow of the process stream 135 can be increased.

In a further embodiment, the first set point temperature may be set to a different value depending upon whether the facility is operating in holding mode or loading mode. For instance, the first set point temperature may be lower in loading mode than in holding mode.

The warmed BOG stream 45 provided by the BOG heat exchanger 40 is then passed to a first stream combining device 230, in which it is combined with the BOG bypass stream 35 to provide a temperature controlled BOG stream 55. The temperature of the temperature controlled BOG stream 55 is determined by the relative mass flows and temperatures of the warmed BOG stream 45 and the BOG bypass stream 55, the latter being at a colder temperature because it has not been warmed in the BOG heat exchanger 40.

A second temperature controller 60 determines the temperature of the temperature controlled BOG stream 55 as a measured second temperature (T2). The second temperature controller 60 is provided with a second set point temperature (SP2), which can be input by an operator. The second temperature controller 60 seeks to move the second temperature (T2) of temperature controlled BOG stream 55 to the second set point temperature (SP2). The second temperature controller 60 brings about the adjustment of the temperature of the temperature controlled BOG stream 55 by controlling the relative mass flows of the warmed BOG stream 45 and the BOG bypass stream 35. The second temperature controller 60 can operate to reduce the warming provided by the BOG heat exchanger 40 to the BOG heat exchanger feed stream 25 by diverting the boil off gas along BOG bypass stream 35.

Normally, the second set point will be lower than the first set point temperature. This would require cooling of the warmed BOG stream 45 such that the colder BOG bypass stream 35 has a positive mass flow during both loading and holding modes. The BOG bypass stream 35 thus operates to lower the temperature of the warmed BOG stream 45 when it is added in first stream combining device 230.

The relative mass flows of the warmed BOG stream 45 and the BOG bypass stream 35 can be controlled by one or more flow control valves (not shown). Such flow controlling valves can be placed in any conduit allowing the adjustment of the mass flow of the relevant stream. The embodiments of FIGS. 2 and 3 show possible locations for these flow control valves, such as in one or more of the BOG bypass stream 35, the BOG heat exchanger feed stream 25 and the warmed BOG stream 45.

The setting of the one or more flow control valves is adjusted by a flow control actuator instructed by a flow control valve signal from the second temperature controller 60. For instance, if the measured second temperature is less than the second set point temperature, the second set point controller 60 will transmit a flow control valve signal instructing one or more flow control actuators to change the setting of one or more flow control valves to increase the relative mass flow of the warmed BOG stream 45 compared to the BOG bypass stream 35, increasing the warming of the BOG bypass stream 35 by the warmed BOG stream 45. Similarly, if the measured second temperature is greater than the second set point temperature, the second set point controller 60 will transmit a flow control valve signal instructing the one or more of the flow control actuators to change the setting of one or more flow control valves to decrease the relative mass flow of the warmed BOG stream 45 compared to the BOG bypass stream 35, increasing the cooling of the warmed BOG stream 45 by the BOG bypass stream 35.

The input second set point temperature of the second temperature controller 60 may depend upon the operational mode of the facility.

During holding mode, the temperature and mass flow of the boil off gas may be low compared to loading mode. The temperature of the BOG stream 15 is normally lower than in loading mode because the only heat entering the storage tank and associated pipework is as a result of leakage through the insulation. The mass flow of the boil off gas is normally lower than in loading mode because there is no carrier vessel to generate additional boil off gas.

In holding mode, the first temperature controller 50 may operate to warm the boil off gas against the process stream 135. If the warmed BOG stream 45 is provided at or close to the second set point temperature, the one or more flow control valves (not shown) of the second temperature controller 60 may operate to significantly restrict the mass flow of the BOG bypass stream 35. Thus, the major mass flow would be to the BOG heat exchanger 40 through BOG heat exchanger feed stream 25, as controlled by the first temperature controller 50 If the warmed BOG stream 45 is provided above the second set point temperature, the one or more flow control valves operated by the second temperature controller 60 may operate to provide mass flow of BOG bypass stream 35 to cool the warmed BOG stream 45 to move the measured second temperature of the temperature controlled BOG stream 55 towards the second set point temperature.

During loading mode, the temperature of BOG feed stream 15 may be higher than in holding mode due to, for instance, superheating from the blowers transferring boil off gas from the carrier vessel. The second temperature controller 60 may detect an increase in the temperature of the controlled temperature BOG stream 55 as a result of the warmer BOG bypass stream 35. As less warming of the boil off gas may be required to provide a stable controlled temperature BOG stream 55, the second temperature controller 60 can operate to increase the mass flow of the BOG bypass stream 35 in relation to the BOG heat exchanger feed stream 25, thus reducing the heat input to the boil off gas.

The mass flow of the boil off gas may significantly increase during loading mode, because of the additional boil off gas produced in the carrier vessel and returned to the apparatus 1. This higher mass flow can be accommodated by increasing the mass flow of the BOG bypass stream 35, which is warmer than in holding mode, compared to the mass flow of the BOG heat exchanger feed stream 25.

In one embodiment, the second set point temperature may be gradually lowered from the set point during holding mode to a different set point during loading mode. This action may be carried out, for instance, if the duty required of the BOG heat exchanger 40 exceeds its design capacity.

Lowering input second set point temperature decreases the target temperature of the temperature controlled BOG stream. This action will result in a decrease in the duty required from the BOG heat exchanger. This action may particularly be carried out during loading mode if the BOG heat exchanger reaches its maximum designed operating duty. Such a decrease in the measured second temperature of the temperature controlled BOG stream may for instance move the optional BOG compressor 80 away from its designed operating temperature, lowering the efficiency of the compression process. However, the second set point temperature and the measured second temperature should preferably be maintained within the designed operational envelope of the BOG compressor in order to avoid damage.

As an alternative, in certain embodiments, an optional warmed BOG stream heater 65 may be provided in the warmed BOG stream to further increase its temperature. For instance, should the heating requirement of the BOG feed stream exceed the duty of the BOG heat exchanger 40 during loading mode, the optional heater 65, if provided, can be used to increase the first measured temperature towards the first set point temperature and/or to provide an increased mass flow rate of the warmed BOG stream at the first set point temperature. The warmed BOG stream heater 65 can also be controlled by the first temperature controller.

In this way, the method and apparatus disclosed herein can provide a temperature controlled BOG stream 55.

In a preferred embodiment, the method and apparatus disclosed herein can be utilised as part of a liquefaction process for a hydrocarbon feed stream. The hydrocarbon feed stream may be any suitable gas stream to be cooled and liquefied, but is usually a natural gas stream obtained from natural gas or petroleum reservoirs. As an alternative the hydrocarbon feed stream may also be obtained from another source, also including a synthetic source such as a Fischer-Tropsch process.

Usually a natural gas stream is a hydrocarbon composition comprised substantially of methane.

Preferably the hydrocarbon feed stream comprises at least 50 mol % methane, more preferably at least 80 mol % methane.

Hydrocarbon compositions such as natural gas may also contain non-hydrocarbons such as H₂O, N₂ᵣ CO₂. Hg, H₂S and other sulphur compounds, and the like. If desired, the natural gas may be pre-treated before cooling and any liquefying. This pre-treatment may comprise reduction and/or removal of undesired components such as CO₂ and H₂S or other steps such as early cooling, pre-pressurizing or the like. As these steps are well known to the person skilled in the art, their mechanisms are not further discussed here.

Thus, the term “hydrocarbon feed stream” may also include a composition prior to any treatment, such treatment including cleaning, dehydration and/or scrubbing, as well as any composition having been partly, substantially or wholly treated for the reduction and/or removal of one or more compounds or substances, including but not limited to sulphur, sulphur compounds, carbon dioxide, water, Hg, and one or more C2+ hydrocarbons.

Depending on the source, natural gas may contain varying amounts of hydrocarbons heavier than methane such as in particular ethane, propane and the butanes, and possibly lesser amounts of pentanes and aromatic hydrocarbons. The composition varies depending upon the type and location of the gas.

Conventionally, the hydrocarbons heavier than methane are removed as far as efficiently possible from the hydrocarbon feed stream prior to any significant cooling for several reasons, such as having different freezing or liquefaction temperatures that may cause them to block parts of a methane liquefaction plant. C2+ hydrocarbons can be separated from, or their content reduced in a hydrocarbon feed stream by a demethaniser, which will provide an overhead hydrocarbon stream which is methane-rich and a bottoms methane-lean stream comprising the C2+ hydrocarbons. The bottoms methane-lean stream can then be passed to further separators to provide Liquefied Petroleum Gas (LPG) and condensate streams.

After separation, the hydrocarbon stream so produced can be cooled. The cooling could be provided by a number of methods known in the art. The hydrocarbon stream is passed against one or more refrigerant streams in one or more refrigerant circuits. Such a refrigerant circuit can comprise one or more refrigerant compressors to compress an at least partly evaporated refrigerant stream to provide a compressed refrigerant stream. The compressed refrigerant stream can then be cooled in a cooler, such as an air or water cooler, to provide the refrigerant stream. The refrigerant compressors can be driven by one or more turbines.

The cooling of the hydrocarbon stream can be carried out in one or more stages. Initial cooling, also called pre-cooling or auxiliary cooling, can be carried out using a pre-cooling mixed refrigerant of a pre-cooling refrigerant circuit, in two or more pre-cooling heat exchangers, to provide a pre-cooled hydrocarbon stream. The pre-cooled hydrocarbon stream is preferably partially liquefied, such as at a temperature below 0° C.

Preferably, such pre-cooling heat exchangers could comprise a pre-cooling stage, with any subsequent cooling being carried out in one or more main heat exchangers to liquefy a fraction of the hydrocarbon stream in one or more main and/or sub-cooling cooling stages.

In this way, two or more cooling stages may be involved, each stage having one or more steps, parts etc. . . . For example, each cooling stage may comprise one to five heat exchangers. The or a fraction of a hydrocarbon stream and/or the mixed refrigerant may not pass through all, and/or all the same, heat exchangers of a cooling stage.

In one embodiment, the hydrocarbon may be cooled and liquefied in a method comprising two or three cooling stages. A pre-cooling stage is preferably intended to reduce the temperature of a hydrocarbon feed stream to below 0° C., usually in the range −20° C. to −70° C.

A main cooling stage is preferably separate from the pre-cooling stage. That is, the main cooling stage comprises one or more separate main heat exchangers. A main cooling stage is preferably intended to reduce the temperature of a hydrocarbon stream, usually at least a fraction of a hydrocarbon stream cooled by a pre-cooling stage, to below −100° C.

Heat exchangers for use as the two or more pre-cooling or any main heat exchangers are well known in the art. The pre-cooling heat exchangers are preferably shell and tube heat exchangers.

At least one of any of the main heat exchangers is preferably a spool-wound cryogenic heat exchanger known in the art. Optionally, a heat exchanger could comprise one or more cooling sections within its shell, and each cooling section could be considered as a cooling stage or as a separate ‘heat exchanger’ to the other cooling locations.

In another embodiment, one or both of the mixed pre-cooling refrigerant stream and any mixed main refrigerant stream can be passed through one or more heat exchangers, preferably two or more of the pre-cooling and main heat exchangers described hereinabove, to provide cooled mixed refrigerant streams.

The mixed refrigerant in a mixed refrigerant circuit, such as the pre-cooling refrigerant circuit or any main refrigerant circuit may be formed from a mixture of two or more components selected from the group comprising: nitrogen, methane, ethane, ethylene, propane, propylene, butanes, pentanes, etc. One or more other refrigerants may be used, in separate or overlapping refrigerant circuits or other cooling circuits.

The pre-cooling refrigerant circuit may comprise a mixed pre-cooling refrigerant. The main refrigerant circuit may comprise a mixed main refrigerant. A mixed refrigerant or a mixed refrigerant stream as referred to herein comprises at least 5 mol % of two different components. More preferably, the mixed refrigerant comprises two or more of the group comprising: nitrogen, methane, ethane, ethylene, propane, propylene, butanes and pentanes.

A common composition for a pre-cooling mixed refrigerant can be:

| | |
|---|---|
| Methane (C1) | 0-20 mol % |
| Ethane (C2) | 5-80 mol % |
| Propane (C3) | 5-80 mol % |
| Butanes (C4) | 0-15 mol % |

The total composition comprises 100 mol %.

A common composition for a main cooling mixed refrigerant can be:

| | |
|---|---|
| Nitrogen | 0-25 mol % |
| Methane (C1) | 20-70 mol % |
| Ethane (C2) | 30-70 mol % |
| Propane (C3) | 0-30 mol % |
| Butanes (C4) | 0-15 mol % |

The total composition comprises 100 mol %.

The pre-cooled hydrocarbon stream, such as a pre-cooled natural gas stream can be further cooled to provide a liquefied hydrocarbon stream, such as an LNG stream. After liquefaction, the liquefied hydrocarbon stream may be further processed, if desired. As an example, the obtained liquefied hydrocarbon may be depressurized by means of one or more expansion devices such as a Joule-Thomson valve and/or a cryogenic turbo-expander.

In another embodiment disclosed herein, the liquefied hydrocarbon stream can be passed through an end gas/liquid separator such as an end-flash vessel to provide an end-flash gas stream overhead and a liquid bottom stream, the latter for storage in one or more liquefied hydrocarbon storage tank as the liquefied product, such as LNG. The boil off gas from such a storage tank can be treated according to the method and apparatus described herein.

Referring to the drawings, FIG. 2 shows a method and apparatus 100 for treating, cooling and liquefying a hydrocarbon feed stream 105 to provide a liquefied hydrocarbon stream 175. The liquefied hydrocarbon stream 175 can be passed to liquefied hydrocarbon storage tank 10, which can provide a BOG stream 15, which can be treated to produce a temperature controlled BOG stream 55.

The hydrocarbon feed stream 105 may be any hydrocarbon or mixture or hydrocarbons, such as natural gas. The hydrocarbon feed stream 105 can be passed to a treatment unit 110, in which the feed stream is treated to remove unwanted contaminants, such as acid gasses and heavier hydrocarbons. Such treatments are known to the skilled person. Acid gasses may be removed from the feed stream by solvent extraction, to provide acid gas stream 95a. Heavier hydrocarbons may be removed by separation in one or more separation columns, such as a scrub column, to provide natural gas liquids (NGLs). A NGL stream 95b is shown leaving the treatment unit 110. Quantities of water present in the hydrocarbon feed stream 105 may also be removed.

Treatment unit 110 provides a treated hydrocarbon stream 115. Treated hydrocarbon stream 115 will be a methane rich stream having a reduced content of acid gasses and NGLs compared to the hydrocarbon feed stream 115.

Treated hydrocarbon stream 115 can be passed to a pre-cooling unit comprising one or more pre-cooling heat exchangers 120. The one or more pre-cooling heat exchangers 120 can cool the treated hydrocarbon stream 115 against a refrigerant, such as a pre-cooling refrigerant in a pre-cooling refrigerant circuit to provide a pre-cooled hydrocarbon stream 125.

The pre-cooled hydrocarbon stream 125 can then be passed to a pre-cooling stream splitting device, which provides a main cooling hydrocarbon feed stream 145 and a process stream 135a, which in this case in a main cooling hydrocarbon bypass stream.

The main cooling hydrocarbon feed stream 145 can be passed to a main cooling unit comprising one or more main cooling heat exchangers 130. The one or more main cooling heat exchangers 130 can cool the main cooling hydrocarbon feed stream 145 against a refrigerant, such as a main refrigerant in a main refrigerant circuit to at least partially, preferably fully, liquefy the hydrocarbon. One or more main heat exchangers provide a liquefied hydrocarbon stream 155a. The liquefied hydrocarbon stream 155a is an at least partially liquefied hydrocarbon stream, and preferably fully liquefied hydrocarbon stream.

One example of the operation of pre-cooling and main refrigerant circuits to cool and liquefy a hydrocarbon stream can be found in U.S. Pat. No. 6,370,910.

The at least partially, preferably fully, liquefied hydrocarbon stream 155a can be combined with cooled process stream 195 to provide (combined) at least partially, preferably fully, liquefied hydrocarbon stream 155b.

The (combined) at least partially, preferably fully, liquefied hydrocarbon stream 155b can then be expanded in one or more end expansion devices 150, such as one or both of a Joule-Thomson valve and a turbo-expander, to provide a expanded partially liquefied hydrocarbon stream 165. Expanded partially liquefied hydrocarbon stream 165 is a two phase stream comprising liquid and vapour components.

The expanded partially liquefied hydrocarbon stream 165 can be passed to an end gas/liquid separator 160, such as an end flash vessel, to provide a liquefied hydrocarbon stream 175 as a bottoms stream and an overhead hydrocarbon stream 185, also known as end flash gas. The liquefied hydrocarbon stream 175 can be a LNG stream when the hydrocarbon feed stream 105 is natural gas.

The liquefied hydrocarbon stream 175 can be passed to the first inlet 4 of a liquefied hydrocarbon storage tank 10. The liquefied hydrocarbon storage tank 10 may comprise a submerged pump 210 for providing the liquefied hydrocarbon to a second outlet 6, where it leaves storage tank 10 as liquefied hydrocarbon feed stream 215. The liquefied hydrocarbon feed stream 215 may transfer the liquefied hydrocarbon to further storage tanks (not shown), for instance in a carrier vessel, such as an LNG carrier.

During the loading of a carrier vessel, boil off gas may be produced in the process of cooling the further storage tanks and/or connecting pipework to the temperature of the liquefied hydrocarbon. This boil of gas can be passed back to second inlet 4 of the liquefied hydrocarbon storage tank 10 as loading boil off gas stream 315. If desired, at least a part of the loading boil off gas stream 315 can be passed directly to boil off gas stream 15 along conduit 335.

As well as optionally comprising a part of the loading boil off gas from conduit 335, the BOG stream 15 may also comprise the overhead hydrocarbon from the end gas/liquid separator 160 from overhead hydrocarbon stream 175.

The BOG stream 15 may then be processed according to the method and apparatus described herein, to provide a temperature controlled BOG stream 55.

In the embodiment shown in FIG. 2, BOG stream 15 is passed to first flow splitting device 220, where it is separated into the BOG heat exchanger feed stream 25a and BOG bypass stream 35a.

The BOG heat exchanger feed stream 25a is passed to a heat exchanger feed stream flow controlling valve 20, which controls the mass flow of the stream to provide a (controlled) BOG heat exchanger feed stream 25b to first inlet 41 of the BOG heat exchanger 40. The BOG bypass stream 35a is passed to a bypass stream flow controlling valve 30, which controls the mass flow of the stream to provide a (controlled) BOG bypass stream 35b.

The BOG stream flow control valve 20 and bypass stream flow control valve 30 are connected to flow control actuators (not shown) which control the setting of the valves. The flow control actuators receive flow control signals along flow control signal line 61 from the second temperature controller 60. As discussed in relation to the embodiment of FIG. 1, changing the setting of flow control valves 20, 30 will adjust the relative mass flow of the (controlled) BOG heat exchanger feed stream 25b (and thus warmed BOG stream 45) and the (controlled) BOG bypass stream 35b, such that the temperature of the temperature controlled BOG stream 55 can be maintained at or close to the second set point temperature.

The temperature controlled BOG stream 55 can then be passed to the inlet 71 of a boil off gas compressor knock out drum 70 in which liquid from the temperature controlled BOG stream 55 can be removed to provide a boil off gas compressor feed stream 75 as an overhead stream at outlet 72.

The BOG compressor feed stream 75 can be passed to the inlet 81 of a boil off gas compressor 80. The BOG compressor feed stream 75 is a temperature controlled stream because it is derived from the temperature controlled BOG stream 55. The suction of the BOG compressor 80 is thus provided with a stream at a controlled temperature. This temperature control allows the operation of the BOG compressor 80 to be maintained within its operational envelope.

Turning to the operation of the BOG heat exchanger 40, the warming of the (controlled) BOG heat exchanger feed stream 25b is provided by a process stream. In this embodiment, the process stream is a main cooling hydrocarbon bypass stream 135a provided from the pre-cooled hydrocarbon stream 125 by a pre-cooling stream splitting device as discussed previously. The main cooling hydrocarbon bypass stream 135a may be provided at a fixed temperature, as produced by one or more pre-cooling heat exchangers 120, such as at least one low pressure propane heat exchanger.

The main cooling hydrocarbon bypass stream 135a is passed to a process stream valve 170 to provide a (controlled) main cooling hydrocarbon bypass stream 135b which is passed to the second inlet 42 of the BOG heat exchanger 40. The mass flow of the (controlled) main cooling hydrocarbon bypass stream 135b is controlled by the setting of the process stream valve 170. The setting of the process stream valve 170 is controlled by a process stream actuator, which receives process control signals from the first temperature controller 50 along process control signal line 51. In this way, the first temperature of the warmed BOG stream 45 can be controlled by changing the mass flow of the (controlled) main cooling hydrocarbon bypass stream 135b.

The BOG heat exchanger cools the (controlled) main cooling hydrocarbon bypass stream 135b against the (controlled) BOG heat exchanger feed stream 25b to provide cooled main cooling hydrocarbon bypass stream 195 as a cooled process stream. When the cooled main cooling hydrocarbon bypass stream 195 is at least partially, preferably fully, liquefied it can be combined with the at least partially, preferably fully, liquefied hydrocarbon stream 155a from the one or more main heat exchangers 130 to provide (combined) at least partially, preferably fully, liquefied hydrocarbon stream 155b. In this way, a portion of the cold energy from the boil off gas can be recycled to a hydrocarbon process stream, so that it can bypass the one or more main heat exchangers 130 in order to reduce the cooling duty of the one or more main heat exchangers 130.

FIG. 3 shows an alternative method and apparatus 100 for treating, cooling and liquefying a hydrocarbon feed stream 105 to provide a liquefied hydrocarbon stream 175. The liquefied hydrocarbon stream 175 can be passed to liquefied hydrocarbon storage tank 10, which can provide a BOG stream 15, which can be treated to produce a temperature controlled BOG stream 55.

In this embodiment, the process stream 135c comprises main refrigerant from the one or more main heat exchangers 130. In particular, the process stream 135c may be a light mixed refrigerant stream derived from a mixed refrigerant separation device in a mixed refrigerant circuit, such as that described in U.S. Pat. No. 6,370,910. Such a light mixed refrigerant stream may be derived from a mixed refrigerant stream by forming a partly condensed mixed refrigerant stream and separating the vapour phase from the partly condensed mixed refrigerant stream, typically by means of the mixed refrigerant separation device, to form the light mixed refrigerant stream. The light mixed refrigerant stream 135c is passed to the second inlet of the BOG heat exchanger 40, where it is warmed against BOG heat exchanger feed stream 25 to provide a cooled light mixed refrigerant stream 195a.

In this case, the mass flow of the light mixed refrigerant through the BOG heat exchanger 40 is controlled by a process stream valve 170a downstream, rather than upstream, of the BOG heat exchanger 40. The process stream valve 170a provides a (controlled) cooled light mixed refrigerant stream 195b which can be returned to the one or more heat exchangers 130. The process stream valve 170a is controlled by a process stream actuator provided with a process control signal in process control signal line 51 from first temperature controller 50. In this way, the first temperature of the warmed BOG stream can be controlled.

The process stream valve 170a may produce a large pressure drop in the process stream, such that a low pressure regime with two phase flow may occur downstream of the valve. It is preferred to produce such a low pressure regime downstream of the BOG heat exchanger 40. If the process stream valve 170a is located upstream of the BOG heat exchanger 40, the exchanger must be adapted to accommodate two phase flow. This can increase the cost of the BOG heat exchanger 40.

The embodiment of FIG. 3 also shows an alternative location for the BOG stream flow control valve 20a, controlled by second temperature controller 60. Rather than being located upstream of the BOG heat exchanger 40 in BOG heat exchanger feed stream 25, it is provided downstream in the warmed BOG stream 45a which exits the first outlet 43 of the heat exchanger 40. The warmed BOG stream 45a is passed to BOG stream flow control valve 20a, which provides a (controlled) warmed BOG stream 45b to be combined with the (controlled) BOG bypass stream 35b in the first stream combining device 230. Thus, the BOG stream flow control valve 20a downstream of the BOG heat exchanger 40 operates to control the mass flow of the warmed BOG stream/BOG heat exchanger feed stream 25. In combination with the bypass stream flow control valve 30, it is possible to control the relative mass flows of the warmed BOG stream/BOG heat exchanger feed stream 25 and the BOG bypass stream 35a/(controlled) BOG bypass stream 35b to provide the temperature controlled BOG stream at the second set point temperature.

The first temperature controller 50 can be situated either upstream or downstream of BOG stream flow control valve 20a. FIG. 3 shows the first temperature controller 50 situated upstream of BOG stream flow control valve 20a in the warmed BOG stream 45a. By placing the first temperature controller 50 upstream of the BOG stream flow control valve 20a, the first temperature can be determined prior to any flow changes to the warmed BOG stream 45a arising from the operation of the BOG stream flow control valve 20a.

In an alternative embodiment (not shown), the first temperature controller 50 can be situated to measure the temperature of the cooled process stream 195. In this case, it is preferred that the first temperature controller 50 is placed between the BOG heat exchanger 40 and the process stream valve 170a, such that the first temperature can be determined prior to any pressure or temperature changes to the cooled process stream 195 arising from the operation of the process stream valve 170a. The first set point temperature would therefore differ from that proposed for the embodiments of FIGS. 1 and 2, and could be in the range of −137 to −162° C. for the cooled process stream 195.

Although the present invention is not limited to such cases, it will have become apparent to the skilled person that the technology described above is particularly advantageous in those cases where the temperature of the boil off gas stream may vary, such as when the liquefaction facility moves between operational modes.

When in holding mode, the boil off gas will be produced primarily from the cryogenic storage tanks. The temperature of the boil off gas will be close to cryogenic temperature. For instance, if the liquefied hydrocarbon is liquefied natural gas (LNG), the boil off gas from the storage tanks may be at a temperature of less than −150° C.

However, when a liquefied hydrocarbon carrier, such as an LNG carrier vessel, arrives to take on the LNG from the liquefaction facility, the facility will move from holding mode to loading mode. During loading mode, the pipework connecting the cryogenic storage tanks of the liquefaction facility and the liquefied hydrocarbon carrier, and the cryogenic storage tanks of the liquefied hydrocarbon carrier may be warmer than cryogenic temperature. The loading process may thus produce boil off gas from liquefied hydrocarbon passing through the connecting pipework and into carrier storage tanks which is significantly warmer than the boil off gas produced by the liquefaction facility cryogenic storage tanks in holding mode. This will be particularly so if the liquefied hydrocarbon itself is used to provide the cooling to the connecting pipework and carrier storage tanks. In addition, the blowers transferring the boil off gas generated in the carrier vessel to the liquefaction facility may superheat the gas, increasing the temperature of the boil off gas.

Furthermore, significantly higher quantities of boil off gas may be produced during loading mode compared to holding mode, because of the additional pipework connecting the storage tanks to the carrier vessel and storage tanks of the carrier vessel.

Thus, during at least the initial stages of the loading mode of the liquefaction facility, boil off gas may be produced at a higher temperature and in greater quantity than that produced during holding mode.

During holding mode, the temperature and mass flow rate of the boil off gas stream may be lower compared to during loading mode. The first temperature controller can operate to maintain the measured first temperature at the first set point by changing the mass flow of the process stream to provide the required heat to the BOG heat exchanger to warm the BOG heat exchanger feed stream until the first set point temperature is reached.

When the second set point temperature of the second temperature controller is selected to be less than the first set point temperature, this can be achieved by reducing the temperature of the warmed BOG stream can be to the second set point temperature by combination with the cooler BOG bypass stream. The BOG bypass stream can be at a lower temperature than the first set point temperature because it has not passed through the BOG heat exchanger. The BOG bypass stream will also usually be colder than the second set point temperature. The second temperature controller can control the relative mass flow rates of one or both of the warmed BOG stream and the BOG bypass stream to achieve the second set point temperature.

For instance, when the measured second temperature is higher than the second set point temperature, the second temperature controller can increase the mass flow rate of the BOG bypass stream and/or reduce the mass flow rate of the BOG heat exchanger feed stream. When the measured second temperature is lower than the second set point temperature, the second temperature controller can decrease the mass flow rate of the BOG bypass stream and/or increase the mass flow rate of the BOG heat exchanger feed stream.

When the facility moves to loading mode, the temperature and mass flow of the boil off gas stream may increase compared to holding mode. The first temperature controller can act to maintain the warmed BOG stream at the first set point temperature by altering the mass flow rate of the process stream to change the duty of the BOG heat exchanger. This may involve increasing the mass flow of the process stream to provide additional warming to the higher mass flow of the BOG feed stream, or decreasing the mass flow of the process stream if less warming of the BOG feed stream is required as a result of its higher temperature.

It will be apparent that in one embodiment, the BOG heat exchanger can be sized to provide the maximum required duty to the BOG feed stream. During loading mode, the additional duty resulting from the increased mass flow of the BOG stream will normally exceed the decrease in duty as a result of the increase in temperature of the BOG stream. Loading mode can therefore produce the maximum BOG heat exchanger duty.

As already discussed, when the second set point temperature of the second temperature controller is selected to be less than the first set point temperature, the temperature of the warmed BOG stream will be reduced to the second set point temperature by combination with the BOG bypass stream. When moving from holding mode to loading mode, the temperature of the BOG bypass stream used to cool the warmed BOG stream will increase. This will be detected as a rise in the measured second temperature by the second temperature controller. Consequently, the second temperature controller can operate to increase the mass flow of the BOG bypass stream and/or reduce the mass flow of the BOG heat exchanger feed stream to lower the temperature of the temperature controlled BOG stream towards the second set point temperature. Viewed another way, the BOG bypass stream, which is at a lower temperature than the warmed BOG stream because it has not been heated in the BOG heat exchanger, can provide cooling to the warmed BOG stream which is passed downstream to the BOG heat exchanger.

When the system returns to holding mode, the temperature and mass flow of the boil off gas stream may fall. This may be detected as a fall in the second measured temperature below the second set point temperature as a result of a drop in the temperature of the BOG bypass stream. For this reason it is preferred that a mass flow in the BOG bypass stream is maintained. The second temperature controller will react by lowering the mass flow of the BOG bypass stream and/or increasing the mass flow of the BOG heat exchanger feed stream in order to raise the temperature of the temperature controlled BOG stream towards the second set point temperature.

The first temperature controller may also detect a fall in the measured first temperature below the first set point temperature as a result of the drop in temperature of the BOG heat exchanger feed stream, which in the absence of a change in the duty provided by the process stream will result in a drop in the temperature of the warmed BOG stream. The first temperature controller may respond by increasing the mass flow of the process stream in order to provide additional cooling of the now lower temperature BOG heat exchanger feed stream, resulting in an increase in the temperature of the warmed BOG stream towards the first set point temperature. In this case, the first and second temperature controllers may detect a reduction in the measured first and second temperatures simultaneously.

In this way, the temperature controlled boil off gas stream can be provided to the BOG compressor at a desired temperature. Such a temperature can be in the range of the temperature of the boil off gas stream and the process stream. The temperature of the boil off gas stream may be dependent upon whether the facility is in holding or loading mode. The present invention can operate to prevent a stream of too low a temperature, such as during holding mode, being passed to the BOG compressor, by providing warming from the process stream.

The person skilled in the art will understand that the present invention can be carried out in many various ways without departing from the scope of the appended claims.

1. A method of handling a boil off gas stream from a cryogenically stored liquefied hydrocarbon inventory, comprising at least the steps of:
providing a boil off gas (BOG) stream from a liquefied hydrocarbon storage tank;
splitting the BOG stream into a BOG heat exchanger feed stream and a BOG bypass stream;
heat exchanging the BOG heat exchanger feed stream in a BOG heat exchanger against a process stream, thereby providing a warmed BOG stream and a cooled process stream;
combining the warmed BOG stream with the BOG bypass stream to provide a temperature controlled BOG stream;
wherein, the mass flow of the process stream is controlled in response to a measured first temperature of at least one of (i) the warmed BOG stream and (ii) the cooled process stream to move the measured first temperature towards a first set point temperature, and
the mass flow of one or both of the BOG heat exchanger feed stream and the BOG bypass stream are controlled in response to a measured second temperature of the temperature controlled BOG stream, to move the measured second temperature towards a second set point temperature.

2. The method according to claim 1, further comprising the steps of:
passing the temperature controlled BOG stream to a BOG compressor knock out drum to provide a BOG compressor feed stream;
compressing the BOG compressor feed stream in a BOG compressor to provide a compressed BOG stream.

3. The method according to claim 1, wherein the process stream is provided at a pre-set process stream temperature.

4. The method according to claim 1, wherein the control of the mass flow of the process stream in response to the measured first temperature of the warmed BOG stream comprises the steps of:
determining the measured first temperature of the warmed BOG stream with a first temperature controller having the first set point temperature;
changing the mass flow of the process stream by adjusting a process stream valve to move the measured first temperature towards the first set point temperature.

5. The method according to claim 1, wherein the control of the mass flow of one or both of the BOG heat exchanger feed stream and the BOG bypass stream in response to the measured second temperature of the temperature controlled BOG stream comprises the steps of:
determining the measured second temperature of the temperature controlled BOG stream with a second temperature controller having the second set point temperature;
changing the mass flow of one or both of the BOG heat exchanger feed stream and the BOG bypass stream by adjusting feed stream valve and bypass stream valve respectively to move the measured second temperature towards the second set point temperature.

6. The method according to claim 1, further comprising:
providing a hydrocarbon feed stream;
liquefying at least part of the hydrocarbon feed stream comprising heat exchanging against at least one refrigerant cycled in a refrigerant circuit to provide a liquefied hydrocarbon stream;
adding at least part of the liquefied hydrocarbon stream to the cryogenically stored liquefied hydrocarbon inventory in the liquefied hydrocarbon storage tank.

7. The method according to claim 6, wherein the process stream comprises at least a part from the hydrocarbon feed stream, which part of the hydrocarbon feed stream after its heat exchanging in the BOG heat exchanger is, at least in part, added to the cryogenically stored liquefied hydrocarbon inventory in the liquefied hydrocarbon storage tank.

8. The method according to claim 7, wherein the part from the hydrocarbon feed stream in the process stream is formed by a slip stream which bypasses at least part of the heat exchanging against said at least one refrigerant cycled in a refrigerant circuit to be heat exchanged in the BOG heat exchanger.

9. The method according to claim 6, wherein the process stream comprises at least a refrigerant stream obtained from the at least one refrigerant cycled in the refrigerant circuit.

10. The method according to claim 6, wherein said adding of the at least part of the liquefied hydrocarbon stream to the cryogenically stored liquefied hydrocarbon inventory comprises the steps of:
expanding the liquefied hydrocarbon stream in one or more end expansion devices to provide an expanded at least partially liquefied hydrocarbon stream;
passing the expanded at least partially liquefied hydrocarbon stream to an end flash vessel to provide a liquefied hydrocarbon stream and an overhead hydrocarbon stream;
passing the liquefied hydrocarbon stream to the cryogenic storage tank; and
adding the overhead hydrocarbon stream to the boil off gas stream.

11. An apparatus for handling a boil off gas (BOG) stream from a cryogenically stored liquefied hydrocarbon inventory, said apparatus comprising at least:
a liquefied hydrocarbon storage tank for storing the liquefied hydrocarbon inventory, the liquefied hydrocarbon storage tank having a first inlet for allowing entry of a liquefied hydrocarbon stream into the liquefied hydrocarbon storage tank and a first outlet for allowing the boil off gas stream to pass out of the liquefied hydrocarbon storage tank;
a first flow splitting device to divide the boil off gas stream into a BOG heat exchanger feed stream and a BOG bypass stream;
a BOG heat exchanger for warming the BOG heat exchanger feed stream by heat exchanging against a process stream, the BOG heat exchanger having a first inlet for receiving the BOG heat exchanger feed stream and a first outlet for discharging a warmed BOG stream, and a second inlet for receiving the process stream and a second outlet for discharging a cooled process stream;
a first stream combining device to combine the BOG bypass stream and the warmed BOG stream to provide a temperature controlled boil off gas stream;
one or more flow control valves to control the mass flow of at least one of the BOG heat exchanger feed stream and the BOG bypass stream;
a process stream valve to control the mass flow of the process stream;
a first temperature controller to determine a measured first temperature of at least one of (i) the warmed BOG stream and (ii) the cooled process stream and having a first set point temperature, said first temperature controller arranged to adjust the process stream valve to move the measured first temperature towards the first set point temperature; and
a second temperature controller to determine a measured second temperature of the temperature controlled boil off gas stream and having a second set point temperature, said second temperature controller arranged to adjust the one or more flow control valves to move the measured second temperature towards the second set point temperature.

12. The apparatus according to claim 11, further comprising:
a BOG compressor knock out drum having an inlet for the temperature controlled BOG stream and an outlet for a BOG compressor feed stream;
a BOG compressor having an inlet connected to the outlet of the BOG compressor knock out drum, for receiving the BOG compressor feed stream, and an outlet for a compressed BOG stream.

13. The apparatus according to claim 11, further comprising:
a main cooling unit comprising one or more main cooling heat exchangers for liquefying at least a part of a hydrocarbon feed stream by heat exchange against a refrigerant, to obtain a liquefied hydrocarbon stream;
a refrigerant circuit for cycling the refrigerant;
which main cooling unit is connected to the liquefied hydrocarbon storage tank to allow adding of at least part of the liquefied hydrocarbon stream to the cryogenically stored liquefied hydrocarbon inventory in the liquefied hydrocarbon storage tank.

14. The apparatus according to claim 13, wherein the second inlet of the BOG heat exchanger is arranged to receive at least a part from the hydrocarbon feed stream whereby the process stream comprises at least a part from the hydrocarbon feed stream, and wherein the second outlet of the BOG heat exchanger is connected to the liquefied hydrocarbon storage tank.

15. The apparatus according to claim 13, wherein the second inlet and the second outlet of the BOG heat exchanger are connected to the refrigerant circuit, whereby the process stream comprises at least a part of the refrigerant.

16. The apparatus according to claim 13, wherein the main cooling unit is connected to the liquefied hydrocarbon storage tank via at least one end expansion device wherein the at least part of the liquefied hydrocarbon stream is expanded to provide an expanded at least partially liquefied hydrocarbon stream, followed by an end gas/liquid separator to provide a liquefied hydrocarbon bottoms stream and an overhead hydrocarbon stream, whereby the liquefied hydrocarbon bottoms stream is passed to the cryogenic storage tank and the overhead hydrocarbon stream is added to the boil off gas stream.
